(19) United States
(12) Patent Application Publication
(10) Pub. No.: US 2025/0244191 A1
(43) Pub. Date: Jul. 31, 2025

(54) TEST LEAK DEVICE

(71) Applicant: INFICON GMBH, Köln (DE)

(72) Inventors: Hendrik VAN TRIEST, Köln (DE); Josef GRENZ, Köln (DE); Daniel WETZIG, Köln (DE)

(73) Assignee: INFICON GMBH, Köln (DE)

(21) Appl. No.: 18/855,573

(22) PCT Filed: Apr. 12, 2023
(86) PCT No.: PCT/EP2023/059552

§ 371 Date: Oct. 9, 2024

(30) Foreign Application Priority Data
Apr. 19, 2022 (DE) 10 2022 109 454.5

(51) Int. Cl. G01M 3/00

(52) U.S. Cl. CPC G01M 3/007

(57) ABSTRACT

A test leak device has an interior surrounded by a housing that can be filled with a test fluid. The housing has a through-opening connecting the interior to the outer surroundings of the test leak device and a membrane that can be brought into or onto the through-opening. The membrane is permeable to the test fluid or to components of the test fluid. The membrane is part of a membrane element that seals the through-opening. The membrane element has a carrier element that is designed to be releasably fastened to the housing to close the through-opening when fastened so that the interior can be filled with test fluid through the through-opening. The carrier element also has an outlet duct that is sealed by the membrane, allowing only the test fluid or its components to escape through the membrane to the outside.

### CROSS-REFERENCE TO RELATED APPLICATIONS

The present application is a national stage application filed under 35 U.S.C. § 371 of PCT Application No. PCT/EP2023/059552, filed on Apr. 12, 2023, which claims priority to German patent application 10 2022 109 454.5, filed on Apr. 19, 2022, the entire contents of all of which are incorporated by reference herein.

### BACKGROUND OF THE DISCLOSURE

### 1. Field of the Disclosure

The disclosure relates to a test leak device for testing the functionality of and for calibrating a leak detection device.

### 2. Description of Related Art

Gas leak detection devices typically comprise an evacuable test chamber into which a test object filled with gas or liquid is placed. The test chamber has a gas analysis device connected thereto which analyzes the gas drawn from the test chamber to detect possible leak gas that has escaped into the test chamber through a leak in the test object or to detect a liquid that escapes through the leak and is evaporated. Here, it is of particular importance to be able to infer the size of the leak from the amount of the leakage gas detected. For this purpose, test leak devices are used which contain a predefined amount of a known test gas or test fluid and are provided with a leak having known dimensions and/or a known permeability to the fluid contained. Test leak devices are typically used to test the functionality of a gas leak detection device and to calibrate the gas leak detection device.

The leak of a test leak device is often designed as a membrane, the leakage rate of which depends on the permeability of the membrane body to the respective test gas or test fluid, the membrane temperature, the temperature and the vapor pressure of the test gas/test fluid, the degree of wetting of the membrane on the inner side/fluid side, and the ventilation on the exit side of the membrane, i.e. on the outer side of the test leak device.

EP 2 447 694 B1, for example, describes a liquid-filled test leak from which gas or vapor or liquid components transported by gas escape. The gases or the vapor or the liquid components transported by the gas, which escape from the test leak, are formed by the liquid as a result of its particular vapor pressure or by permeation through a solid layer of a membrane.

The leak rate of a membrane test leak depends on whether and to what degree the inner side of the membrane is wetted with liquid. In this regard, it can have a significant influence on the leakage rate, whether the membrane is in direct contact with a liquid or only with a liquid vapor. In order to obtain a stable leakage rate, it should either be prevented that liquid reaches the membrane or it should be ensured that only liquid vapor comes into contact with the membrane.

DE 10 2014 200 907 B4 describes a reference outgassing system with a reservoir containing a fluid or a fluid mixture. A transport vacuum chamber surrounds the reservoir. A chamber pressure of less than 10 kPa prevails in the transport vacuum chamber.

DE 10 2020 116 939 A1 describes a test leak device in which the base of the reservoir for the test fluid tapers conically towards the membrane. It is mentioned that the membrane is fastened with screws. A separate filling opening is described for filling the reservoir with test fluid.

### SUMMARY OF THE DISCLOSURE

It is an object of the present disclosure to provide an improved refillable test leak device.

The test leak device according to the disclosure has an interior surrounded by a housing and fillable with a test fluid. The housing is provided with a through opening that connects the interior with the external environment of the test leak device. A membrane which is permeable to the test fluid or to components of the test fluid is provided to be attached to the through-opening in such a way that test fluid or components of the test fluid can pass from the interior through the membrane to the outside via the through-opening. The membrane preferably has a predetermined, known permeability so that the test fluid leaves the test leak device with a known leakage rate.

The particular feature of the disclosure is that the passage opening is used to fill the interior with test fluid, whereas in the prior art separate filling openings are provided for this purpose and the passage opening closed with the membrane is used exclusively to allow the test fluid to escape from the interior into its external environment.

For this purpose, the diaphragm is part of a diaphragm element that fits on or in the through opening in a sealing manner and has a carrier element designed for detachable attachment to the housing. The carrier element is preferably made of a rigid material, such as stainless steel. The carrier element is designed in such a way that it closes the passage opening when attached to the housing. To fill the interior with test fluid, the carrier element is detached from the housing and test fluid is filled into the interior through the through-opening, after which the carrier element is reattached to the housing, thereby closing the through-opening.

The carrier element is provided with an outlet channel that completely penetrates the same from a first side to its opposite second side. The outlet channel is closed by the membrane in such a way that only test fluid or components of the test fluid can pass from the interior through the membrane to the outside. The connection between the carrier element and the housing is necessarily fluid-tight and therefore in particular also gas-tight.

The passage opening typically has a larger opening diameter than the outlet channel, so that the interior can be quickly refilled with test fluid, for example with the aid of a filling nozzle that matches the passage opening, while the diameter of the outlet channel is independent of that of the passage opening and is adapted to the size of the membrane or has the dimensions required for the test fluid to escape from the interior.

The test leak device according to the disclosure is thus easily refilled via the through-opening without the need for separate filling openings, thus enabling a technically simplified and more reliable design. While conventional test leak devices are either not refillable or can only be refilled via separate filling openings, according to the disclosure, in order to refill the test leak device, the attachment of the carrier element to the housing is first loosened and the membrane element is removed from the through-opening. The interior is then filled with test fluid via the through-opening, for example by inserting a suitable filling nozzle into the through-opening. After filling, the carrier element is reattached to the housing so that a fluid-tight, i.e. liquid- and gas-tight, connection is created between the carrier element and the housing and test fluid or components of the test fluid can only escape from the interior through the membrane.

The permeability of the membrane element can be measured after the membrane has been connected to the carrier element, before the membrane element is connected to the housing. This means that the leak rate of the test leak device can be determined and defined based on the qualification of the membrane on the carrier element, and therefore independently of the housing.

The carrier element can be designed as a flange. The outlet channel can be formed in the center of the carrier element. Fastening devices distributed around the outlet channel can be provided for fastening the carrier element to the housing.

In particular, the carrier element can be designed as a flange that enables attachment to a mating flange of a test chamber that is complementary to the flange in such a way that test fluid can escape from the interior of the test leak device directly into the interior of the test chamber through the flange connection created. For this purpose, the flange of the test leak device is attached to the mating flange of the test chamber in a fluid-tight and detachable manner. In this manner, an easy way of testing the functionality and calibrating a leak detection device is provided without having to open the test chamber and place the test leak device in the test chamber.

The fastening devices can, for example, be screw holes, while corresponding threaded openings are formed in the housing so that, when the carrier element is in the fastened state, each screw hole is aligned with a corresponding threaded opening so that a screw can be screwed into the corresponding threaded opening through each screw hole.

It is advantageous if a separate sealing ring is arranged between the carrier element and the housing, which surrounds the through-opening in plan view, in particular to seal the through-opening against the threaded openings and screw holes. The sealing ring can be metallic, e.g. in the form of a copper ring (“CF vacuum technology”) or in the form of an aluminum ring (as an “ultra seal”). The sealing ring is replaced after a filling process. A metallic seal is preferable here because it is not permeable to gases and liquids and does not store gases and liquids and release them again with a delay, as is the case with elastomer seals. Additional permeation through the seal or outgassing would falsify the actual calibration.

The outlet channel can also be cylindrical. The diameter of the outlet channel is smaller than that of the passage opening. While the diameter of the through-opening must be sufficiently large for quick, easy and safe filling, the diameter of the outlet channel can be sufficiently small for a targeted escape of the test fluid from the interior at a predetermined leak rate.

The membrane is preferably designed as an element covering the outlet channel, for example in the form of a disk. The membrane can be attached to the outside of the carrier element opposite the interior and can, for example, be firmly bonded or pressed to the carrier element. A recess surrounding the outlet channel can be formed in the surface of the carrier element for the carrier element, into which the membrane fits precisely. Preferably, the membrane in the recess is firmly bonded or pressed to the carrier element. The membrane can also be covered by a protective grid that supports the membrane and is attached to the carrier element.

Preferably, the test leak device according to the disclosure does not have a separate filling opening for filling the interior with test fluid, so that the interior can only be refilled with test fluid through the through opening.

In one embodiment, a cover cap can be provided that covers the carrier element and is connected to or attached to the housing. The connection between the cover cap and the housing is preferably detachable. The cover cap provides a protective function for the membrane and for the carrier element.

The housing of the test leak device has a base, a cover and at least one side wall connecting the base to the cover, the base, the cover and the side wall enclosing the interior which can be filled with the test fluid. The test fluid can be a test gas or a test liquid. The membrane is permeable to the test gas or to components of the test liquid, so that only the test gas or components of the test liquid can escape from the test leak device through the membrane.

### BRIEF DESCRIPTION OF THE DRAWINGS

In the following, an exemplary embodiment of the disclosure is explained in more detail with reference to the Figures.

FIG. 1 is a perspective section through the embodiment.

FIG. 2 is a cross-section through the embodiment according to FIG. 1.

FIG. 3 is an exploded view of an embodiment.

### DETAILED DESCRIPTION OF THE DISCLOSURE

The test leak device 10 has a housing 11 with a base 12 which is integrally connected to a circumferential side wall 14 projecting laterally from the outer edge of the base. A cover 16 is connected with the side wall 14 in a fluid-tight manner, so that the base 12, the side wall 14 and the cover 16 enclose an interior 20 in a fluid-tight manner. The interior 20 can therefore be filled with a test fluid, i.e. a test gas or a test liquid. The base 12, the circumferential side wall 14 and the cover 16 form the housing 11.

A through-opening 22 is formed in the base 12, connecting the interior 20 with the external environment 13 of the test leak device 10, into which opening a membrane element 24 is inserted, which has a membrane 25 permeable to the test fluid or to components of the test fluid. Thereby, the test fluid contained in the interior 20 can escape from the test leak device 10 only via the membrane 25.

The diaphragm element 24 has a cylindrical carrier element 42 which, as a body of rotation, has an axis of rotation which, in the state shown in FIG. 2, in which the carrier element 42 is connected to the housing 11, coincides with the axis of rotation of the housing 11, which is also rotationally symmetrical. The axis of rotation of the carrier element 42 and the housing 11 is shown as a dotted line in FIG. 2.

The carrier element 42 is penetrated completely by an outlet channel 44 extending concentrically through the center of the carrier element along its axis of rotation, so that an outer end face of the carrier element facing the environment 13 is connected by the outlet channel 44 to the opposite end face of the carrier element 42 facing the interior 20.

The side wall 14 is configured as a ring circumferentially protruding from the base 12 in a cylindrical shape along the outer circumference of the base 12, the inner side 26 of which forms a cone that tapers towards the membrane device 24 and the passage opening 22. At its lower end facing the base 12, the cone has a central opening that opens into the passage opening 22 and adjoins the membrane device 24.

Due to the fact that the base 12 and the side wall 14 are integrally connected with each other, the cone of the inner side 26 can also be seen as a recess in the base 12.

Due to the effect of gravity and the diameter of the interior 20 tapering towards the passage opening 22 and the membrane 25, the test fluid contained in the interior 20 runs or flows along the inner side 18 into the passage opening 22 and towards the membrane 25. The membrane is thus uniformly wetted by test fluid as soon as the test leak device 10 stands upright on a substrate, e.g. the base of the test chamber of a gas leak detection device not illustrated in the Figures.

The underside 28 of the base 12 has a bulge 30 formed in the manner of a plate and concentrically surrounding the through opening 22. The membrane element 24 is inserted in the lower end of the passage opening 22. The passage opening 22 opens into the interior 20 with a reduced diameter when compared to the membrane element 24. As a result, a cylindrical recess surrounded by the curvature 30 is formed in the base 12, into which the membrane element 24 is inserted. The recess completely accommodates the membrane element 24.

The through opening 22 is concentrically surrounded by screw holes 40 formed in the base 12, into which fastening elements in the form of screws for fastening the membrane element 24 are inserted and held there by a conventional screw connection with threaded engagement. The carrier element 42 is provided with threaded channels or threaded openings 46, which are arranged concentrically around the outlet channel 44 and are aligned with the screw holes 40 in such a way that a screw 48 is screwed into a screw hole through each threaded opening 46. This holds the carrier element 42 firmly but detachably on the housing 11.

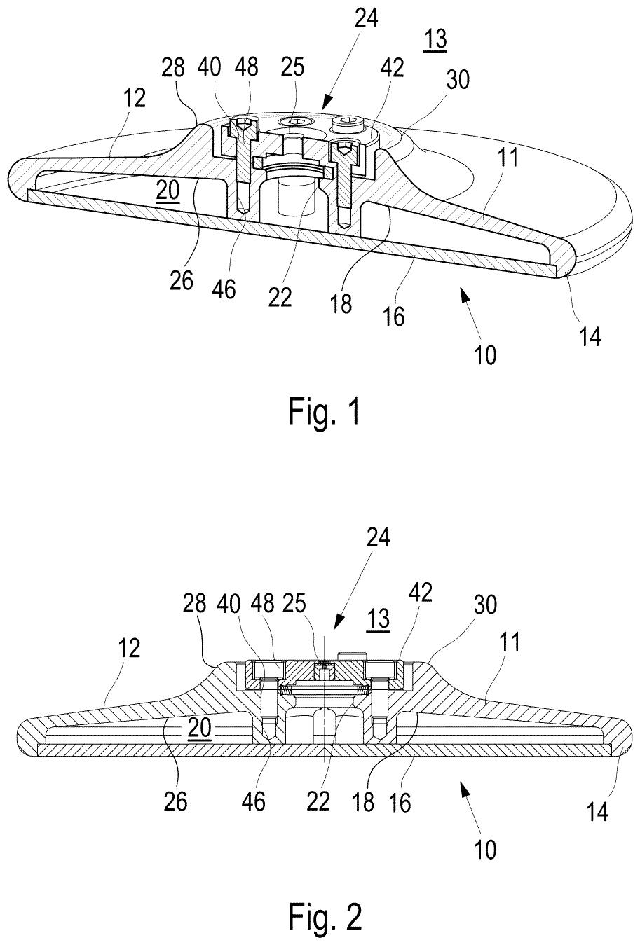

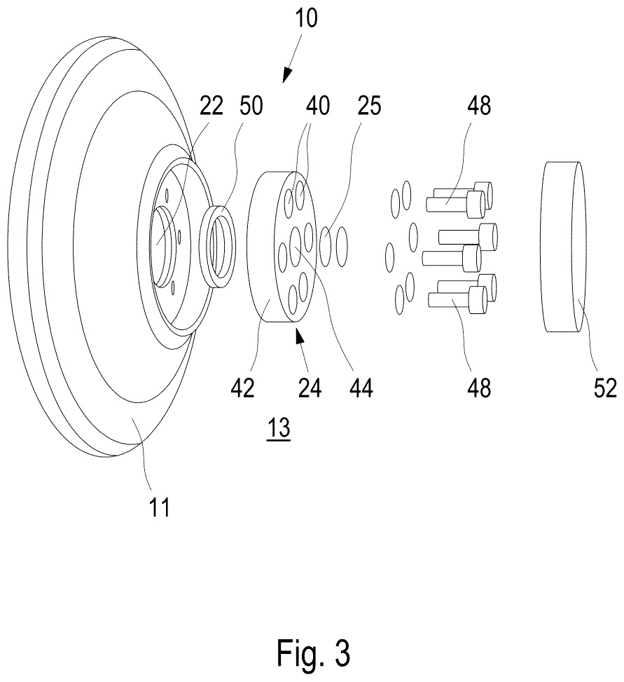

A sealing ring 50 in the form of a copper ring (“CF vacuum technology”) is provided between the carrier element 42 and the housing 11, which surrounds the outside of the through opening 22 and forms a fluid-tight seal between the carrier element 42 and the housing 11. This means that no test fluid can get out of the through channel into the screw holes 40 or the threaded openings 46. In the state shown in FIGS. 1 and 2, only test fluid can pass through the membrane 25 from the interior 20 into the external environment 13.

To refill the test leak device 10, first the screws 48 are unscrewed from the threaded openings 46 and the membrane device 24 is removed from the through-opening 22. The interior 20 is then filled with test fluid through the through opening 22. The sealing ring 50 is replaced with a new sealing ring if necessary, for example in the event of wear. The sealing ring is then placed in the opening provided between the housing 11 and the carrier element 42 and the carrier element 42 is then screwed tightly to the housing 11 again using the screws 48. The membrane 25 remains firmly bonded or pressed to the carrier element 42 and does not need to be removed.

1. A test leak device for testing and calibrating a leak detection device that has a test chamber that can be evacuated and can accommodate a test object and/or the test leak device, the test leak device comprising:
a housing defining an interior space that can be filled with a test fluid;
a through-opening formed in the housing that connects the interior space to an exterior of the test leak device;
a membrane that can be positioned in or on the through-opening,
wherein the membrane is permeable to the test fluid or to components of the test fluid;
a membrane element including the membrane that fits in or on the through-opening to seal the through-opening;
a carrier element forming part of the membrane element,
wherein the carrier element can be releasably fastened to the housing,
wherein, when the carrier element is fastened to the housing, the carrier element which closes the through-opening,
wherein, when the carrier element is unfastened, the carrier element exposes the through-opening to allow filling of the interior space with the test fluid; and
an outlet duct formed through the carrier element,
wherein the outlet duct is sealed by the membrane so that only test fluid or components of the test fluid can escape from the interior space through the membrane and to the exterior.

2. The test leak device according to claim 1, wherein the carrier element is configured as a flange that can be mounted to a complementary counter flange of a test chamber to form a flange connection allowing test fluid to flow directly from the interior space of the test leak device into an interior of the test chamber via the membrane and the flange connection.

3. The test leak device according to claim 1, wherein the carrier element has fastening devices distributed concentrically around the outlet duct for fastening to the housing.

4. The test leak device according to claim 3, wherein, when the carrier element is fastened to the housing, the fastening devices are screw holes that are brought into alignment with corresponding threaded openings in the housing so that a screw can be screwed through each screw hole into a corresponding threaded opening.

5. The test leak device according to claim 1, further comprising:
a sealing ring,
wherein, when the carrier element is fastened to the housing, the sealing ring surrounds the through-opening in plan view and is arranged between the carrier element and the housing.

6. The test leak device according to claim 5, wherein the sealing ring is metallic.

7. The test leak device according to claim 1, wherein the membrane is a disc covering the outlet duct and the membrane is arranged in a recess surrounding the outlet duct in the carrier element.

8. The test leak device according to claim 1, wherein the test leak device lacks a separate filling opening for introducing test fluid into the interior space so that the interior space can only be refilled with test fluid through the through-opening.

9. The test leak device according to claim 1, wherein the carrier element is covered by a cover cap connected to the housing.

10. A method for filling a test leak device according to claim 1, the method comprising the steps of:
loosening the carrier element from the housing and removing the membrane element from the through-opening,
filling the interior space with test fluid through the through-opening, and
refastening the carrier element to the housing so that the through-opening is sealed by the membrane element so that only test fluid or components of the test fluid can escape from the interior space through the membrane to outside the housing.

11. The method according to claim 10, wherein the carrier element is configured as a flange that can be mounted to a complementary counter flange of a test chamber to form a flange connection so that test fluid can pass from the interior space of the test leak device through the membrane and through the flange connection directly into an interior of the test chamber.
